(19) United States
(12) Patent Application Publication
(10) Pub. No.: US 2025/0034342 A1
(43) Pub. Date: Jan. 30, 2025

(54) BIAXIALLY ORIENTED POLYESTER FILM

(71) Applicant: TOYOBO CO., LTD., Osaka (JP)

(72) Inventors: Taichi ZUSHI, Tsuruga (JP); Akira SHIMIZU, Tsuruga (JP); Shotaro NISHIO, Osaka (JP)

(73) Assignee: TOYOBO CO., LTD., Osaka (JP)

(21) Appl. No.: 18/713,454

(22) PCT Filed: Nov. 17, 2022
(86) PCT No.: PCT/JP2022/042696

§ 371 Date: May 24, 2024

(30) Foreign Application Priority Data
Nov. 26, 2021 (JP) 2021-192210

(51) Int. Cl. C08J 5/18; B32B 27/08; B32B 27/36

(52) U.S. Cl. CPC C08J 5/18; B32B 27/08; B32B 27/36; B32B 2250/03; B32B 2250/244; B32B 2250/40; B32B 2270/00; B32B 2272/00; B32B 2307/414; B32B 2307/518; B32B 2307/538; C08J 2367/02

(57) ABSTRACT

Provided is a biaxially stretched polyester film having good print visibility and a smooth surface by material-recycling a film to be discarded. Provided is also a biaxially stretched polyester film which can be used as a substrate film in a release film for producing a resin sheet. A biaxially stretched polyester film has a haze of 2% or more and 15% or less and a surface roughness SRa of at least one surface of 5 nm or more and 40 nm or less.

### TECHNICAL FIELD

The present invention relates to a biaxially stretched polyester film. In particular, the present invention relates to a laminated film including a substrate and a functional layer, and particularly to a biaxially stretched polyester film useful as the substrate of a process film.

### BACKGROUND ART

A laminated film including a functional layer that generates various functions on the surface of a substrate film such as a synthetic resin is used as a process film. As the substrate film, a biaxially stretched polyester film is used. The process film is utilized in the fields of, for example, electronic components, optical components, labels, and releasing.

In the above process film, a used film, a non-standard film, and a film damaged in a distribution process, and the like are usually discarded (hereinafter, such a film may be referred to as a film to be discarded).

Patent Document 1 discloses a method for measuring the amount of impurities in a used film, a method for recycling a used film, and a method for forming a recycled raw material into a film.

For example, Patent Document 1 discloses removing a silicone-containing release layer and a layer to be released (barium titanate, pressure-sensitive adhesive) formed on the surface of a substrate film as a residue.

### PRIOR ART DOCUMENT

### Patent Document

Patent Document 1: JP-A-2021-115862

### SUMMARY OF THE INVENTION

### Problems to be Solved by the Invention

In order to effectively utilize resources, it is preferable to recycle the film to be discarded. In particular, the distribution amount of a laminated film (process film) including a functional layer and a substrate, for example, a release film has been on an increasing trend in recent years, the amount of waste of the release film has also been increasing, and the release film have been required to be recycled and utilized. In addition, films made of 100% recycled raw materials have also been required in recent years. In particular, a film for a process for molding an IC chip and protecting a polarizing plate to be finally discarded is required to be a film made of 100% recycled raw materials.

The film to be discarded may contain particles depending on required properties. However, Patent Document 1 does not disclose a specific recycling method for recycling a substrate film containing particles. Therefore, a recycling means for a film containing particles is also required.

For example, Patent Document 1 focuses on barium titanate, which is an object to be released, and silicone contained in a release layer as impurities, but only a method for recycling a PET film containing no particles is disclosed for a substrate in a release film.

Therefore, when the release film not containing particles described in Patent Document 1 is recycled and the whole amount of the release film is formed into a film as a recycled raw material, there is a concern that the resulting film may be a film with reduced windability.

In recent years, a laminated film, for example, a process film used for a release film is required to have print visibility in various processes, and a recycled film is also required to have improved print visibility.

However, the technique of Patent Document 1 tends not to satisfy desired print visibility.

Furthermore, a film having a low surface roughness is also required from the viewpoint of surface transfer to a processed product.

Therefore, an object of the present invention relates to a film containing particles to be discarded, particularly a biaxially stretched polyester film which is obtained from a raw material from which a laminated film, for example, a release film, has been recovered, has excellent print visibility, and has a low surface roughness.

### Means for Solving the Problems

As a result of intensive studies to solve the above problems, the present inventors have found that the above problems can be solved by controlling a haze and a surface roughness in predetermined ranges in a recycled film, and have completed the present invention.

In recent years, for the purpose of shortening the operation process, the process film has been increasingly required to satisfy the visibility of printing even under various process conditions. Therefore, as a result of intensive studies on improvement of print visibility in a process film such as a release film, the present inventors have found that it is necessary to control the haze of the process film among various factors in order to improve the print visibility in the process film.

However, for example, if the print visibility is simply improved, characteristics originally required for the release film and the like may become insufficient.

For this reason, when the biaxially stretched polyester film is used as a substrate in a process film such as a release film, it is necessary to improve the visibility of printing, and to satisfy the improvement of the peelability of a processed product and the suppression of transfer of a surface shape to the processed product caused by the substrate in a well-balanced manner.

As described above, it is also required to recycle a film to be discarded containing particles.

In view of such circumstances, the present inventors have developed a biaxially stretched polyester film having, for example, the improvement of the visibility of printing, the retention of good peelability, and the suppression of transfer of the surface shape even in a process film produced again from a resin obtained by recycling a film containing particles in a well-balance manner.

The configuration of the present invention is as follows.
(1) A biaxially stretched polyester film having a haze of 2% or more and 15% or less and a surface roughness SRa of at least one surface of 5 nm or more and 40 nm or less.
(2) The biaxially stretched polyester film according to the present invention, comprising 80 mass % or more and 100 mass % or less of a resin obtained by material-recycling a used film with a functional layer containing one or more kinds of inorganic particles or organic particles.
(3) The biaxially stretched polyester film according to the present invention, wherein the biaxially stretched polyester film has an intrinsic viscosity IV of 0.50 dl/g or more and 0.70 dl/g or less.

### Effect of the Invention

According to the present invention, it is possible to provide a biaxially stretched polyester film having both improved visibility of printing and suppression of transfer of a surface shape to a processed product in a well-balanced manner. The present invention can provide a biaxially stretched polyester film having both the improvement of visibility of printing and the suppression of transfer of a surface shape to a processed product in a well-balanced manner even when a recycled resin obtained from a film containing particles by material recycling or the like is used.

### MODE FOR CARRYING OUT THE INVENTION

Hereinafter, the present invention will be described in detail.

The present invention is a biaxially stretched polyester film having a haze of 2% or more and 15% or less, preferably 5% or less and 15% or less, and a surface roughness SRa of at least one surface of 5 nm or more and 40 nm or less. In one aspect, the biaxially stretched polyester film of the present invention contains 80 mass % or more and 100 mass % or less of a resin obtained by material-recycling a used film with a functional layer containing one or more kinds of inorganic particles or organic particles in 100 mass % of the biaxially stretched polyester film.

(Used Film with Functional Layer)

The laminated film including the functional layer and the substrate may be a laminated film before use or a used laminated film. In one aspect, the laminated film including the functional layer and the substrate may be a used laminated film with a functional layer (hereinafter, may be referred to as a used film with a functional layer).

In one aspect, the laminated film is a release film used for molding a resin sheet containing an inorganic compound. Examples of the inorganic compound include metal particles, metal oxides, and minerals, and specific examples thereof include calcium carbonate, silica particles, aluminum particles, and barium titanate particles.

Examples of a resin include a polyvinyl acetal resin and a poly(meth)acrylic acid ester resin.

For example, the laminated film is used for producing a resin sheet required to have high smoothness, such as a semiconductor component, a ceramic green sheet, or an optical film. By recycling the laminated film used for such applications, various physical properties such as a haze and a surface roughness in the present invention can be more effectively exhibited. The laminated film (release film) used for such applications preferably contains particles in order to exhibit windability while maintaining smoothness.

The used film with a functional layer of the present invention is a film in which a functional layer is provided on at least one surface of a thermoplastic layer resin substrate film, and a substrate polyester film is not particularly limited in terms of a material and a shape and the like.

Particularly preferably, a laminated film with a functional layer in which a functional layer is directly laminated on a substrate is used. By using the laminated film with a functional layer in which the functional layer is directly laminated on the substrate, the substrate with less impurities can be recycled, so that the haze and surface roughness according to the present invention can be more effectively obtained.

As the material of the polyester film contained in the substrate, polyethylene terephthalate, polyethylene naphthalate, polybutylene terephthalate, and polycyclohexanedimethanol-terephthalate and the like can be used without particular limitation.

As the substrate film, a single material may be used, a mixed system such as a polymer alloy may be used, or a structure in which a plurality of types of multiple materials are laminated may be used.

In one aspect, the polyester-based resin contained in the polyester film is preferably an aromatic polyester obtained by polycondensation of a diol component and an aromatic dicarboxylic acid component from the viewpoint of dynamic characteristics and reducing surface defects, and examples of the aromatic dicarboxylic acid component include terephthalic acid, isophthalic acid, 2,6-naphthalenedicarboxylic acid, 4,4′-diphenyldicarboxylic acid, and 6,6′-(alkylenedioxy)di-2-naphthoic acid such as 6,6′-(ethylenedioxy)di-2-naphthoic acid, and examples of the diol component include ethylene glycol, 1,4-butanediol, 1,4-cyclohexanedimethanol, and 1,6-hexanediol. Among them, from the viewpoint of dimensional stability during processing at a high temperature, those having ethylene terephthalate or ethylene-2,6-naphthalenedicarboxylate as a main repeating unit are preferable, and those having ethylene-2,6-naphthalenedicarboxylate as a main repeating unit are particularly preferable. From the viewpoint of further improving dimensional stability against environmental changes, those obtained by copolymerizing a 6,6′-(ethylenedioxy)di-2-naphthoic acid component, a 6,6′-(trimethylenedioxy)di-2-naphthoic acid component, and a 6,6′-(butylenedioxy)di-2-naphthoic acid component and the like described in WO 2008/096612 A brochure are also preferable.

In the polyethylene terephthalate, the content of the repeating unit of ethylene terephthalate is preferably 90 mol % or more, and more preferably 95 mol % or more. Small amounts of other dicarboxylic acid component and diol component may be copolymerized with the polyethylene terephthalate. From the viewpoint of cost, the polyethylene terephthalate is preferably produced only from terephthalic acid and ethylene glycol. Known additives such as an antioxidant, a light stabilizer, an ultraviolet absorber, and a crystallization agent may be added as long as the effects of the film of the present invention are not impaired. The polyester film is preferably a stretched polyester film for reasons such as high bidirectional elastic modulus.

In the present invention, it is necessary to control the haze to a predetermined condition, and the used film with a functional layer desirably contains particles. For example, one or more kinds of inorganic particles or organic particles can be contained.

The contained particles are not limited to specific inorganic particles and organic particles, and examples thereof include inorganic particles such as titanium oxide, barium sulfate, calcium carbonate, calcium sulfate, silica, alumina, talc, kaolin, clay, calcium phosphate, mica, hectorite, zirconia, tungsten oxide, lithium fluoride, and calcium fluoride, and organic polymer particles such as styrene-based particles, acryl-based particles, melamine-based particles, benzoguanamine-based particles, and silicone-based particles. A film obtained by adding two or more kinds in combination may be used. It is preferable that calcium carbonate or silica having high versatility is contained.

The average particle diameter of the particles contained in the film substrate as a raw material of the polyester film of the present invention is preferably 0.2 μm or more and 4.0 μm or less, and more preferably 0.4 μm or more and 3.6 μm or less. When the average particle diameter is 0.2 μm or more, the haze can be increased, and the print visibility is good, which is preferable. When the average particle diameter is 4.0 μm or less, the unevenness of the surface is reduced, so that there is no transfer to a processed product, which is preferable.

The content of the particles is preferably 100 ppm or more and 10,000 ppm or less, and more preferably 300 ppm or more and 8000 ppm or less with respect to the film substrate. When the content is 100 ppm or more, the haze is increased, and the print visibility is improved, which is preferable. When the content is 10,000 ppm or less, the haze does not become too high and is suitable for inspection of a processed product and the like.

Even when the used film with a functional layer does not contain particles, the biaxially stretched polyester film of the present invention can be obtained. In this aspect, for example, in the step of recycling the used film with a functional layer, particles under the conditions described in the present specification may be added.

The functional layer of the used film with a functional layer of the present invention is not particularly limited, and may contain resins such as silicone-based, cyclic olefin-based, acyclic olefin-based, fluorine-based, alkyd-based, acryl-based, melamine-based, and epoxy-based resins.

In particular, when the functional layer is used as a release layer, a residual substance of an object to be released may be present on the surface of the release layer. Therefore, in the present invention, the removing step including removing the attachable matter from the film including the functional layer is important (described in detail later).

For example, a pressure-sensitive adhesive, an optical film, and a ceramic green sheet and the like can be shown as the object to be released, and a part of these can be present as the attachable matter according to the present invention.

The release layer of the present invention is also required to have high adhesion to the object to be released. For example, a release layer for a pressure sensitive adhesive, a release layer for an optical film, and a release layer for a ceramic green sheet can be used in a step for producing an object to be released and a step for producing a device or the like using the object, and therefore it is necessary to exhibit high adhesion between these steps.

The release layer in the present invention may be a release layer exposed to a high temperature (for example, 60° C. or higher) and/or high humidity (for example, 70% or higher) conditions, or a release layer subjected to high stretching conditions. The removing step, which includes removing an attachable matter from a film including a functional layer (for example, a release layer exposed under these conditions), can increase the purity of a recycle substrate, and for example, can provide required optical properties and mechanical strength and the like.

A silicone-based compound is a compound having a silicone structure in the molecule, and examples thereof include curable silicone, a silicone graft resin, and a modified silicone resin such as an alkyl-modified silicone resin.

As the reactive curable silicone resin, an addition reaction type silicone resin, a condensation reaction type silicone resin, and an ultraviolet ray or electron beam curing type silicone resin and the like can be used.

Examples of the addition reaction type silicone resin include an addition reaction type silicone resin in which polydimethylsiloxane having a vinyl group introduced at a terminal or a side chain is reacted with hydrodienesiloxane using a platinum catalyst to be cured. At this time, it is more preferred to use a resin that can be cured at 120° C. within 30 seconds because processing can be performed at a low temperature.

Examples thereof include low-temperature addition curing type silicone resins (LTC1006L, LTC1056L, LTC300B, LTC303E, LTC310, LTC314, LTC350G, LTC450A, LTC371G, LTC750A, LTC752, LTC755, LTC760A, and LTC850 and the like) and heat UV curing type silicone resins (LTC851, BY24-510, BY24-561, and BY24-562 and the like) manufactured by Dow Corning Toray Co., Ltd., and solvent addition type silicone resins (KS-774, KS-882, and X62-2825 and the like), solvent addition+UV curing type silicone resins (X62-5040, X62-5065, X62-5072T, and KS5508 and the like) and dual curing type silicone resins (X62-2835, X62-2834, and X62-1980 and the like) manufactured by Shin-Etsu Chemical Co., Ltd.

Examples of the condensation reaction type silicone resin include a silicone resin in which polydimethylsiloxane having an OH group at a terminal and polydimethylsiloxane having an H group at a terminal are subjected to a condensation reaction using an organotin catalyst to form a three-dimensional crosslinked structure.

Examples of the ultraviolet curing type silicone resin include, as the most basic type, a silicone resin utilizing the same radical reaction as that of usual silicone rubber crosslinking, a silicone resin photocured by introducing an unsaturated group, a silicone resin in which an onium salt is decomposed with ultraviolet rays to generate a strong acid, and an epoxy group is cleaved and crosslinked by the strong acid, and a silicone resin crosslinked by the addition reaction of thiol to vinylsiloxane. An electron beam can also be used instead of the ultraviolet rays. The electron beam has higher energy than that of the ultraviolet rays, and makes it possible to perform a crosslinking reaction by radicals without using an initiator as in the case of ultraviolet curing.

Examples of the resin to be used include UV-curing type silicones (X62-7028A/B, X62-7052, X62-7205, X62-7622, X62-7629, and X62-7660 and the like) manufactured by Shin-Etsu Chemical Co., Ltd., UV-curing type silicones (TPR6502, TPR6501, TPR6500, UV9300, UV9315, XS56-A2982, and UV9430 and the like) manufactured by Momentive Performance Materials Inc., and UV-curing type silicones (Silicoleases UV POLY200, POLY215, POLY201, and KF-UV265AM and the like) manufactured by Arakawa Chemical Industries, Ltd.

As the ultraviolet curing type silicone resin, acrylate-modified or glycidoxy-modified polydimethylsiloxane or the like can also be used. These modified polydimethylsiloxanes can be mixed with a polyfunctional acrylate resin or an epoxy resin or the like, and used in the presence of an initiator.

The cyclic olefin-based resin contains a cyclic olefin as a polymerization component. The cyclic olefin is a polymerizable cyclic olefin having an ethylenic double bond in the ring, and can be classified into a monocyclic olefin, a bicyclic olefin, and a tricyclic or more polycyclic olefin and the like.

Examples of the monocyclic olefin include cyclic C4-12 cycloolefins such as cyclobutene, cyclopentene, cycloheptene, and cyclooctene.

Examples of the bicyclic olefin include 2-norbornene; norbornenes having an alkyl group (C1-4 alkyl group) such as 5-methyl-2-norbornene, 5,5-dimethyl-2-norbornene, 5-ethyl-2-norbornene, and 5-butyl-2-norbornene; norbornenes having an alkenyl group such as 5-ethylidene-2-norbornene; norbornenes having an alkoxycarbonyl group such as 5-methoxycarbonyl-2-norbornene and 5-methyl-5-methoxycarbonyl-2-norbornene; norbornenes having a cyano group such as 5-cyano-2-norbornene; norbornenes having an aryl group such as 5-phenyl-2-norbornene and 5-phenyl-5-methyl-2-norbornene; octaline; and octalines having an alkyl group such as 6-ethyl-octahydronaphthalene.

Examples of the polycyclic olefin include dicyclopentadiene; derivatives such as 2,3-dihydrodicyclopentadiene, methanooctahydrofluorene, dimethanooctahydronaphthalene, dimethanocyclopentadienonaphthalene, and methanooctahydrocyclopentadienonaphthalene; derivatives having a substituent such as 6-ethyl-octahydronaphthalene; adducts of cyclopentadiene and tetrahydroindene, and trimers and tetramers of cyclopentadiene.

The acyclic olefin-based resin contains an acyclic olefin as a polymerization component. Examples of the acyclic olefin include alkenes such as ethylene, propylene, 1-butene, isobutene, 1-pentene, 2-methyl-1-butene, 3-methyl-1-butene, 1-hexene, 3-methyl-1-pentene, 4-methyl-1-pentene, 1-heptene, 1-octene, 1-decene, 1-dodecene, 1-tetradecene, 1-hexadecene, 1-octadecene, and 1-icosene.

Rubber can also be used as a resin for surface treatment. Examples thereof include copolymers such as butadiene and isoprene.

Regardless of the cyclic olefin and the acyclic olefin, the olefin-based resin may be used alone, or two or more thereof may be copolymerized.

The cyclic olefin-based resin and the acyclic olefin-based resin may partially have a hydroxyl group-modified or acid-modified site, and may be crosslinked with their functional groups using a crosslinking agent. The crosslinking agent may be appropriately selected according to a modification group, and examples thereof include isocyanate-based crosslinking agents such as aromatic diisocyanates (such as tolylene diisocyanate, 2,4-tolylene diisocyanate, 4,4′-diphenylmethane diisocyanate, xylylene diisocyanate, and polymethylene polyphenyl isocyanate), lower aliphatic diisocyanates (such as tetramethylene diisocyanate and hexamethylene diisocyanate), and alicyclic isocyanates (such as cyclopentylene diisocyanate, cyclohexylene diisocyanate, isophorone diisocyanate, and hydrogenated products of the aromatic diisocyanates), as well as melamine-based crosslinking agents such as a methyl etherified melamine resin and a butyl etherified melamine resin, and epoxy-based crosslinking agents.

The fluorine-based compound is not particularly limited as long as the fluorine-based compound is a compound having at least one of a perfluoroalkyl group and a perfluoroalkyl ether group. The fluorine-based compound may be partially modified with an acid, a hydroxyl group, or an acrylate group or the like. A crosslinking agent may be added to make crosslinking to occur at a modified site. Alternatively, a compound having at least one of a perfluoroalkyl group and a perfluoroalkyl ether group may be added to a UV curable resin, followed by polymerizing. Alternatively, a small amount of a compound having a perfluoroalkyl group having no reactive functional group may be added to a binder resin.

A release agent such as a polyolefin-based release agent, a long-chain alkyl group-containing resin-based release agent, a fluorine-based release agent, or a silicone-based release agent may be used as a release layer of a release film and as a main resin, or may be used as an additive of a binder resin.

The binder resin is not particularly limited, and for example, a UV-curable resin obtained by curing a functional group such as an acrylic group, a vinyl group, or an epoxy group by UV irradiation, a thermoplastic resin such as an ester-based resin, a urethane-based resin, an olefin-based resin, or an acrylic resin, or a thermosetting resin such as an epoxy-based resin or a melamine-based resin can also be used.

(Step of Removing Attachable Matter from Film Including Functional Layer)

In the method for removing the attachable matter from the film including the functional layer of the present invention, the film including the functional layer is provided with the functional layer on at least one surface of the substrate, and for example, the attachable matter may remain on the surface of the film after the use of the film including the functional layer.

In the above film, the used film, the non-standard film, and the film damaged in the distribution process, and the like are usually discarded. A step of removing the attachable matter from such a film to be discarded is included.

The present invention may include removing the attachable matter not only from the surface of the functional layer but also from the surface of the substrate opposite to the functional layer. The method may include a step of removing the attachable matter attached to the substrate.

In one aspect, the resin obtained by material-recycling the used film with a functional layer is a resin from which the functional layer and/or an object adhering to the functional layer (for example, a material to be released) has been removed. The substrate film before recycling, that is, the film from which the functional layer has been removed, may contain particles in an amount of 0.01 parts by mass or more and 1.0 parts by mass or less, for example, 0.03 parts by mass or more and 1.0 parts by mass or less, for example, 0.21 parts by mass or more and 1.0 parts by mass or less, with respect to 100 parts by mass of the film substrate before recycling.

By containing the particles in such a range, in addition to obtaining the above-described effects on the haze and the surface roughness, the recycled film, that is, the biaxially stretched polyester film of the present invention can also have good rigidity, moisture resistance, and blocking resistance.

Although it should not be construed as being limited to a specific theory, in the present invention, the substrate film contains a predetermined amount of particles, thereby not only providing the required haze and surface shape, but also providing additional functions such as rigidity in a well-balanced manner. For this reason, for example, a step of removing particles which have been conventionally treated as impurities has been required, but in the present invention, a step of actively removing particles can be omitted as long as the haze and the surface shape according to the present invention are obtained.

In one aspect, the film from which the functional layer has been removed may contain 0.01 parts by mass or more and 1.0 parts by mass or less, for example, 0.21 parts by mass or more and 1.0 parts by mass or less, of a functional layer residue and a residue adhering to the functional layer, for example, a material to be released, with respect to 100 parts by mass of the film substrate before recycling. By containing the residue in such a range, the effects on a haze and a surface roughness according to the present invention can be exhibited.

The method in which the remaining attachable matter is removed is not particularly limited, and examples thereof include a method in which a pressure-sensitive adhesive roll is attached and an attachable matter is removed at the time of peeling off, a method in which an attachable matter is removed by sucking with a vacuum, a method in which an attachable matter is scraped with a blade, a method in which an attachable matter is removed with high pressure water and high pressure air, a method in which an attachable matter is removed by blowing sand or dry ice, a method in which an attachable matter is adsorbed and removed with microbubbles or the like in a state where a film is immersed in a cleaning layer, a method in which an attachable matter is floated and removed with fine vibration such as ultrasonic waves, and a method in which an attachable matter is dissolved and removed with supercritical CO2. These methods may be combined.

These methods are not particularly limited, but a method capable of providing roll-to-roll processing is preferable in terms of efficiency.

This step may be omitted as long as the final film properties are not impaired. In the step, the functional layer may be removed together with the attachable matter, or the functional layer may remain on the film without being removed.

Here, in the present invention, the step of removing the attachable matter from the film including the functional layer includes removing the pressure-sensitive adhesive, the ceramic green sheet, and impurities and the like remaining on the surface of the functional layer. The step may be a step of removing the functional layer from the substrate. Preferably, the step of removing the attachable matter is a step of removing a functional layer, for example, a release layer or an easily slipping layer, from the substrate. By removing the functional layer, the recovery rate of the resin derived from the substrate film can be increased, and even in the recycled film after recycling, various physical properties that are not inferior to those of the substrate before recycling can be exhibited.

In one aspect, the biaxially stretched polyester film in the present invention contains a resin obtained by separating a substrate portion from a used or unused film with a functional layer and material-recycling the substrate portion. For example, for a release film to be used for production of a ceramic green sheet, it is desirable to remove a residue (referred to as an attachable matter) of an object to be released (green sheet) and a release layer, and to material-recycle the substrate portion.

In one aspect, when the release layer contains a silicone-based compound, it is desirable to recycle the substrate from which the release layer has been removed from the release film.

In particular, in an A/B/A layer configuration in which an A layer is provided on both surfaces of a B layer, the B layer is made of a first composition containing a release layer and recycled PET obtained by recycling a substrate, but the A layer is more desirably made of a second composition containing recycled PET obtained by recycling only a substrate from which not only an attachable matter but also a release layer has been removed. With this configuration, the A layer exposed to the surface can have high smoothness.

The recycled film (biaxially stretched polyester film of the present invention) can further reduce the content of barium titanate and silicone and the like by material-recycling the substrate portion. In the present invention, since it is necessary to control a predetermined haze and surface roughness, it is desirable that the resin to be subjected to material-recycling does not substantially contain barium titanate.

Barium titanate tends to be present in a state of being dispersed in the recycled film, and further, barium titanate tends to be present in a state of being aggregated, so that it may be difficult to control a predetermined haze and surface roughness according to the present invention.

When the recycled film is used again as a release film for a ceramic green sheet, particularly as the substrate in the release film, barium titanate which may be present near the surface of the substrate may slip down, which may interfere with the characteristics of the ceramic green sheet to be produced. Therefore, in the present invention, it is desirable to material-recycle at least the release film from which the barium titanate has been removed.

In the present invention, the phrase “substantially free of barium titanate” means a content that is 50 ppm or less, preferably 10 ppm or less, and most preferably equal to or less than the detection limit when an inorganic element is quantitatively determined by fluorescent X-ray analysis. This is because, even if the barium titanate is not positively added into the recycled film, contamination components derived from foreign matters, and raw material resins or dirt attached to lines or devices in film producing steps may be peeled off and mixed into the film.

### (Step of Pulverizing Film)

The present invention includes, as the step 2, a pulverizing step including pulverizing at least a substrate to form a pulverized product. In one aspect, the functional layer from which the attachable matter has been removed may be further pulverized, and then mixed with the pulverized matter of the substrate. In the present invention, at least a pulverized product obtained by pulverizing a substrate may be mixed with a functional layer pulverized product obtained by pulverizing a functional layer from which an attachable matter has been removed and the pulverized matter of the substrate. The pulverized product may be obtained in a state where the functional layer from which the attachable matter has been removed and the substrate are laminated, or after the functional layer from which the attachable matter has been removed and the substrate may be separated, and then pulverized using the same pulverizer, or may be pulverized in different steps using different pulverizers.

The film with the functional layer can be pulverized using a pulverizer such as a single-screw pulverizer, a biaxial pulverizer, a triaxial pulverizer, or a cutter mill. Specifically, rotors in which a plurality of rotary blades are circumferentially attached at regular intervals are housed in a housing to which a plurality of fixed blades are attached, and a solid material is pulverized by cutting the solid material between the tip of each rotary blade and the tip of each fixed blade rotated by the rotation of the rotor. A pulverized matter passing through a screen of a predetermined mesh is obtained. Any known method can be used as long as the material is pulverized to a predetermined size.

The pulverized matter obtained by pulverizing in the pulverizing step is, for example, flaky, powdery, massive, or strip-shaped, but it is preferable that the pulverized matter includes a flaky matter. The flaky pulverized matter refers to a scale or flat pulverized matter.

The size of a screen hole used in the pulverizing step is preferably 1 mm or more and 10 mm or less, and more preferably 3 mm or more and 8 mm or less. When the size of the screen hole is less than 1 mm, the pulverized product becomes powdery and is difficult to handle, and the size thereof is preferably 1 mm or more. When the size is 10 mm or more, the bulk density becomes too low, and it is difficult to control a discharge amount in an extruding step to be described later, and therefore the size is preferably 10 mm or less.

When the width of the film with the functional layer is narrow, for example, 20 mm or less, the film may be cut in a machine direction.

### (Step of Producing Recycle Chip)

The present invention includes a chipping step including chipping the pulverized product obtained in the step 2 to form a recycle chip.

In the method for producing the recycle chip, it is desirable to granulate the pulverized matter by melt-extruding. Examples of a granulating apparatus include a single screw extruder, a twin screw extruder, and a multi-screw extruder, and any known apparatus can be used. A granulation form may be any of a cylindrical shape, a pillow shape, a spherical shape, and an elliptical spherical shape.

### (Step of Producing Film)

The present invention includes a recycle film forming step including forming the recycle chip obtained in the above step into a film and winding the obtained film.

The intrinsic viscosity (IV) of the biaxially stretched polyester film according to the present invention is preferably 0.50 dl/g or more and 0.70 dl/g or less, for example, 0.51 dl/g or more and 0.65 dl/g or less, and more preferably 0.51 dl/g or more and 0.62 dl/g or less. The intrinsic viscosity is particularly preferably 0.51 dl/g or more and 0.58 dl/g or less.

When the intrinsic viscosity is 0.50 dl/g or more, breakage is less likely to occur in a stretching step, which is preferable. Biaxial stretching can be performed without impairing film formability.

Furthermore, when the intrinsic viscosity is 0.70 dl/g or less, the cuttability of the biaxially stretched polyester film at the time of being cut into a predetermined product width is good and dimensional failure does not occur, which is preferable. The filter filtration pressure can be suppressed, which causes no problem in operability. It is preferable that the raw material is sufficiently vacuum-dried.

For example, also in an aspect in which the biaxially stretched polyester film according to the present invention is a film obtained by forming a recycled chip into a film, it is desirable that the biaxially stretched polyester film exhibits the above-mentioned intrinsic viscosity.

In one aspect, the biaxially stretched polyester film of the present invention containing a resin obtained by material-recycling a film with a functional layer containing one or more kinds of inorganic particles or organic particles can satisfy the condition of an intrinsic viscosity (IV) of 0.50 dl/g or more and 0.70 dl/g or less, and preferably the condition of 0.51 dl/g or more and 0.58 dl/g or less.

In the present invention, it should not be construed as being limited to a specific theory, but it is presumed that when the recycled resin contains particles, problems such as an increase in a cooling time and deterioration in quality during film formation can be suppressed, and temperature unevenness during film formation can be suppressed. It is presumed that the recycled resin also contribute to the improvement of the smoothness of the surface shape of the obtained film.

Therefore, the haze and the surface roughness SRa according to the present invention can be guided to predetermined ranges, and for example, a biaxially stretched polyester film having excellent print visibility and a low surface roughness can be obtained.

The method for biaxially stretching the polyester film in the present invention is not particularly limited, and methods generally used conventionally can be used. For example, the polyester can be obtained by melting the polyester with an extruder, extruding the melted product into a film form, cooling the extruded product with a rotary cooling drum to obtain an un-stretched film, and biaxially stretching the un-stretched film. A biaxially stretched film can be obtained by a method in which a film uniaxially stretched in a machine direction or a transverse direction is sequentially stretched biaxially in the transverse direction or the machine direction, or a method in which the un-stretched film is simultaneously stretched biaxially in the machine direction and the transverse direction.

A filter may be used between a time when the recycle chip is brought into a molten state and a time when the molten product is extruded. As the filter used for such filtration, a filter known per se may be appropriately adopted according to the level of the intended surface defect. In general, a filter having smaller 95% filtration accuracy (particle diameters of glass beads remaining on a filter without allowing 95% or more of glass beads to pass when glass beads are allowed to pass) can remove smaller foreign matters. Therefore, the 95% filtration accuracy of the filter to be used is preferably 30 μm or less, and more preferably 20 μm or less from the viewpoint of reducing foreign matters that form minute surface defects as a problem in the present invention. Meanwhile, the smaller the 95% filtration accuracy is, the more the foreign matters can be removed, which means that the foreign matters trapped without passing through the filter is more quickly accumulated. When such foreign matters that cannot pass through the filter are accumulated, the amount of the thermoplastic resin that can pass through the filter are reduced even if the thermoplastic resin is filtered, and the amount of the thermoplastic resin extruded into a sheet becomes unstable, or the trapped foreign matters leak from the filter due to a pressure at which the filter tries to push out the thermoplastic resin. Therefore, the lower limit of the 95% filtration accuracy of the filter is not limited, but is preferably 5 μm or more, and more preferably 10 μm or more. Note that, when the foreign matters accumulated in this manner leak out, products thereafter become defective products.

Such a filter for a molten resin may also be placed between a molten state and extrusion at the time of producing a recycle chip. The filtration accuracy of the filter at this time may be appropriately selected according to the defect level in the intended resin, and it is preferable to select a filter size capable of removing aggregates and the like of the functional layer unnecessary for film physical properties without removing those required for the film physical properties, for example, particles and the like for maintaining easily slippery.

The film formation method in the present invention is not limited, but specifically, a material-recycled polyester pellet is sufficiently vacuum-dried, then supplied to an extruder, melt-extruded into a sheet shape at about 255 to 280° C., and cooled and solidified to form an un-stretched PET sheet. The obtained un-stretched sheet is stretched 3.0 to 6.0 times in the machine direction using rolls heated to 75° C. to 140° C. to obtain a uniaxially oriented PET film. Furthermore, the ends of the film are gripped with clips, and the film is guided to a hot air zone heated to 75° C. to 140° C., dried, and then stretched 3.0 to 6.0 times in the transverse direction. Subsequently, the stretched film can be guided to a heat treatment zone at 180° C. to 260° C. and subjected to a heat treatment for 1 to 60 seconds. During this heat treatment step, a relaxation treatment of 0% to 10% may be performed in the transverse direction or the machine direction, if necessary.

The polyester film preferably has a thickness of 12 to 100 μm, more preferably 12 to 85 μm, and still more preferably 15 μm to 80 μm. When the thickness of the film is 12 μm or more, there is no fear that the film is deformed by heat during film production or when the film is used as a process film, which is preferable. Meanwhile, when the thickness of the film is 100 μm or less, the amount of the film to be discarded after use is not extremely increased, which is preferable in reducing the environmental load, and furthermore, the material per area of the release film to be used is reduced, which is also preferable from the economic viewpoint.

The polyester film substrate may include a single layer or two or more layers. In the case of a laminated polyester film having a multilayer structure of two or more layers, a three-layer structure of A layer/B layer/A layer is preferable. In that case, in order to impart slipperiness for winding the film into a roll shape, it is preferable that 100 to 800 ppm of particles of 2 μm or more are contained on the A layer which is the surface layer. A coating layer containing a binder may be applied during film formation.

In the polyester film substrate in the present invention, silica particles and/or calcium carbonate particles are preferably contained from the viewpoint of the slipperiness of the film of the A layer as the surface layer and the easiness of air release.

Whether the substrate includes a single layer or two or more layers, the content of the contained particles is preferably 500 to 10000 ppm in all layers.

The surface average roughness (SRa) of the film surface is 5 nm or more and 40 nm or less, and preferably 5 nm or more and 35 nm or less. More preferably, the surface average roughness is 5 nm or more and 25 nm or less. The surface average roughness (SRa) of the film surface may satisfy the above conditions in at least one surface, and both surfaces of the film may satisfy the above conditions.

For example, a resin layer substantially not containing inorganic particles, for example, a polyester resin layer may be provided on the functional layer side in the A layer as the surface layer, and a resin layer substantially not containing particles having a particle diameter of 1.0 μm or more, for example, a polyester resin layer may be provided on the functional layer side in the A layer as the surface layer.

When the content of the particles is 500 ppm or more, the haze can be increased, the print visibility is improved, and the front and back surfaces can be distinguished by clearly confirming the printed surface. Thus, the workability for confirming the front and back surfaces can be improved, which is efficient. When the SRa is 5 nm or more, air can be uniformly released when the film is wound up into a roll shape in both the production and use of the film, and the film is suitable for the production of a super-thin layer ceramic green sheet because of its good winding appearance and good flatness. When the total content of the particles is 10,000 ppm or less and the SRa is 40 nm or less, the unevenness of the surface can be suppressed, and the transfer of the unevenness to a molded article can be prevented.

In the film containing the recycled resin, it is more preferable to use silica particles and/or calcium carbonate particles as particles contained in the film from the viewpoint of transparency and cost. Inert inorganic particles and/or heat-resistant organic particles and the like can be used in addition to silica and/or calcium carbonate particles, and examples of other inorganic particles that can be used include alumina-silica composite oxide particles and hydroxyapatite particles. Examples of the heat-resistant organic particles include crosslinked polyacrylic particles, crosslinked polystyrene particles, and benzoguanamine-based particles. When silica particles are used, porous colloidal silica is preferable, whereas when calcium carbonate particles are used, light calcium carbonate surface-treated with a polyacrylic acid-based polymeric compound is preferable from the viewpoint of preventing the lubricant from falling off.

In the film containing the recycled resin, the average particle diameter of the particles is preferably 0.2 μm to 4.0 μm, and more preferably 0.4 μm to 3.6 μm. When the average particle diameter is 0.2 μm or more, the haze can be increased, and the print visibility is good, which is preferable. When the average particle diameter is 4.0 μm or less, the unevenness of the surface is reduced, so that there is no transfer to a processed product, which is preferable.

The content of the particles is preferably 100 to 10000 ppm, and more preferably 300 to 8000 ppm, with respect to the film substrate. When the content is 100 ppm or more, the haze is increased, and the print visibility is improved, which is preferable. When the content is 10,000 ppm or less, the haze does not become too high and is suitable for inspection of a processed product and the like.

The average particle diameter of the particles can be measured by a method in which particles in the cross section of a processed film are observed with a scanning electron microscope, 100 particles are observed, and the average value thereof is taken as the average particle diameter. The shape of the particles is not particularly limited as long as the shape of the particles satisfies the object of the present invention, and spherical particles and non-spherical particles having an indefinite shape can be used. The particle diameter of the particles having an indefinite shape can be calculated as an equivalent circle diameter. The equivalent circle diameter is a value obtained by dividing the area of the observed particles by the circular constant (n), calculating the square root, and doubling the square root.

The film may contain two or more kinds of different particles. The same type of particles having different average particle diameters may be contained.

Examples of the method for adding particles include a method of side feeding during material recycling, a method of preparing a master batch by melting and kneading a raw material obtained by material recycling and particles, and mixing two or more kinds of material recycled raw materials, and the method is not limited to these methods.

The coating layer may impart functionality. Means for providing the coating layer is not particularly limited, but it is preferable to provide the coating layer by a so-called in-line coating method in which coating is performed during the formation of a polyester film.

In the present invention, the haze of a biaxially stretched polyester film using a raw material obtained by material-recycling a used film with a functional layer is 2% or more and 15% or less, and may be, for example, 5% or more and 15% or less, and more preferably 5.5% or more and 12% or less. The biaxially stretched polyester film having such a haze has excellent print visibility. In particular, when the haze is 5% or more, the printing can be easily visually recognized due to fogging of the film, and the printed surface can be easily determined. When the haze is 15% or less, the processed product can be visually recognized with appropriate transparency, so that inspection and a defect detector are not hindered.

In addition, in the present invention, since the surface roughness also has a predetermined condition, it is possible to suppress the transfer of unevenness to a processed product (object to be released).

In one aspect, the biaxially stretched polyester film of the present invention contains a material-recycled raw material in an amount of 80 mass % or more and 100 mass % or less with respect to 100 mass % of the biaxially stretched polyester film. For example, the material-recycled raw material is contained in an amount of 85 mass % or more and 100 mass % or less, for example, 90 mass % or more and 100 mass % or less.

When the material-recycled raw material is contained in an amount of 80 mass % or more, the amount of a petroleum-derived raw material used can be reduced, and it can be said that the film is an environmentally friendly film.

When the biaxially stretched polyester film has a multilayer structure, for example, when the A layer has a two-layer structure, the material-recycled raw material contained in the A layer can be appropriately blended so that the total of the two layers is 80 mass % or more and 100 mass % or less.

In one aspect, the three-dimensional ten-point average roughness (SRz) of the film is 1300 nm or less, and may be, for example, 750 nm or less. The lower limit of SRz is preferably as close as possible to zero from the viewpoint of smoothness. However, the lower limit value of SRz is sufficient to be 0.05 μm in consideration of the fact that surface smoothing at an extreme level requires an extremely advanced technique, the measurement accuracy of a measuring instrument for detecting the surface smoothing, a practical light reflectance, and stable productivity at an industrial level. When the SRz is within the above range, the surface unevenness of the biaxially stretched polyester film can be suppressed from propagating to the functional layer, for example, the release layer when the functional layer, for example, the release layer is laminated on the biaxially stretched polyester film of the present invention.

In one aspect, the maximum protrusion height (SRp) of the film is 1300 nm or less, and may be, for example, 850 nm or less. For example, the maximum protrusion height (SRp) may be 100 nm or more or 300 nm or more. By providing the maximum protrusion height in such a range, good slipperiness can be obtained, and furthermore, air release in the roll can be made good, an increase in wrinkles during winding can be suppressed, and handleability and roll appearance can be satisfactorily maintained.

### (Resin Sheet)

In one aspect, the biaxially stretched polyester film of the present invention can be used as a substrate in a release film for molding a resin sheet.

The biaxially stretched polyester film is not particularly limited as long as the biaxially stretched polyester film is a resin sheet, and may be applied to the production of a pressure-sensitive adhesive and an optical film. In one aspect, the release film for forming a resin sheet contains an inorganic compound. Examples of the inorganic compound include metal particles, metal oxides, and minerals, and specific examples thereof include calcium carbonate, silica particles, aluminum particles, and barium titanate particles.

Examples of a resin include a polyvinyl acetal resin and a poly(meth)acrylic acid ester resin.

The biaxially stretched polyester film of the present invention is suitable for the lamination of a release layer having high smoothness, and even in an aspect in which these inorganic compounds are contained in a resin sheet, it is possible to suppress defects that may be caused by the inorganic compounds, for example, problems such as breakage of the resin sheet and difficulty in peeling the resin sheet from the release layer.

Resin components forming the resin sheet can be appropriately selected according to the application.

In one aspect, the resin sheet containing an inorganic compound is a ceramic green sheet. For example, the ceramic green sheet can contain barium titanate as the inorganic compound. In one aspect, the resin sheet has a thickness of 0.2 μm or more and 1.0 μm or less.

### EXAMPLES

Hereinafter, the present invention will be described in more detail with reference to Examples, but the present invention is not limited to the following Examples. Characteristic values used in the present invention were evaluated using the following methods.

### (1) Intrinsic Viscosity (IV)

A film or polyester resin was crushed, dried, and then dissolved in a mixed solvent of phenol/tetrachloroethane=60/40 (mass ratio). This solution was centrifuged to remove inorganic particles, the flow time of the solution having a concentration of 0.4 (g/dl) at 30° C. and the flow time of only the solvent were then measured using an Ubbelohde viscometer, and the intrinsic viscosity was calculated from the ratio of these times using the Huggins equation assuming that the Huggins constant is 0.38.

### (2) Total Light Transmittance, Haze

A total light transmittance was measured using a turbidimeter (NDH5000 manufactured by Nippon Denshoku Industries Co., Ltd.) in accordance with JIS K 7136: 2000.

### (1) Film Thickness

A film sample was nipped in a spindle detector (K107C manufactured by Anritsu Electric Co., Ltd.). Using a digital differential electronic micrometer (K351 manufactured by Anritsu Electric Co., Ltd.), a thickness was measured at 10 different positions, and an average value thereof was calculated and taken as a film thickness.

### (4) Surface Roughness (SRa)

Using a probe type three-dimensional roughness meter (SE-3AK, manufactured by Kosaka Laboratory Ltd.) under the conditions including a needle radius of 2 μm and a load of 30 mg, an outermost layer surface of a biaxially stretched film was measured in a machine direction of the film at a cutoff value of 0.25 mm over a measurement length of 1 mm at a needle feed speed of 0.1 mm/sec and then divided into 500 points at a pitch of 2 μm, and the height of each point was taken into a three-dimensional roughness analyzer (SPA-11). The same operation as this was continuously performed 150 times at intervals of 2 μm in a transverse direction of the film, that is, over 0.3 mm in the transverse direction of the film, and the data was taken into the analyzer. Next, a center surface average roughness (SRa) and a ten-point average roughness (SRz), and a center line crest height (SRp) were determined using the analyzer.

### (5) Average Particle Diameter

A roughening agent was observed with a scanning electron microscope (Model S-510, manufactured by Hitachi, Ltd.), and the magnification was appropriately changed according to the size of particles, and a photograph taken was enlarged and copied. Subsequently, for at least 200 or more randomly selected particles, the outer periphery of each particle was traced. The equivalent circle diameters of the particles were measured from the trace images with an image analyzer, and the average thereof was taken as an average particle size.

### (Evaluation of Print Visibility)

The obtained polyester film was marked with an oil-based marker pen to evaluate visibility.

The evaluation results are as follows.
◯ The print visibility was good, and the printed surface could be clearly confirmed.
Δ The printed surface could be confirmed.
x Misrecognition of whether the printed surface is a front surface or a back surface occurred.

### (Preparation of Recycled Resin)

A used PET film including a silicone-based release layer on one surface and containing 600 ppm of calcium carbonate having a particle diameter of 1.0 μm was used. An attachable matter adhering to the surface of the PET film were removed by a sandblasting method. The film from which the attachable matter had been removed was pulverized by a 4 mm hole screen at a speed of 100 kg/hour in a uniaxial pulverizer to obtain a pulverized product of the film. The obtained pulverized product was charged into an extrusion granulator to obtain recycled PET 1. The intrinsic viscosity at this time was 0.57 dl/g.

Used PET films having different kinds, particle sizes, and contents of inorganic particles as shown in Table 1 were granulated in the same manner to obtain recycled PETs 2 to 7.

### (Preparation of Polyethylene Terephthalate Pellets (PET (I))

As an esterification reactor, a continuous esterification reactor composed of a three-stage complete mixing tank including a stirrer, a demultiplexer, a raw material inlet, and a product outlet was used, TPA was set to 2 ton/hr, EG was set to 2 mol with respect to 1 mol of TPA, and antimony trioxide was set to an amount such that an Sb atom was 160 ppm with respect to produced PET. The slurry was continuously supplied to a first esterification reaction can of the esterification reactor, and reacted at normal pressure at 255° C. for an average retention time of 4 hours.

Next, the reaction product in the first esterification reaction can was continuously taken out of the system, and supplied to a second esterification reaction can. 8% by mass of EG distilled off from the first esterification reaction can with respect to a produced polymer (produced PET) was supplied into the second esterification reaction can. Furthermore, an EG solution containing magnesium acetate set such that the amount of Mg atoms with respect to the produced PET was set to 65 ppm and an EG solution containing TMPA set such that the amount of P atoms with respect to the produced PET was set to 20 ppm were added, and reacted at 260° C. at normal pressure for an average residence time of 1.5 hour. Subsequently, the reaction product in the second esterification reaction can was continuously taken out of the system and supplied to a third esterification reaction can, and an EG solution containing TMPA set such that the amount of P atoms with respect to the produced PET was 20 ppm was further added. The mixture was reacted at 260° C. at normal pressure for an average residence time of 0.5 hours. The esterification reaction product produced in the third esterification reaction can was continuously supplied to a three-stage continuous polycondensation reactor to perform polycondensation, and filtered through a filter medium of a stainless-steel sintered body (nominal filtration accuracy: 5 μm particles 90% cut) to obtain PET (I) as a polyethylene terephthalate pellet having an intrinsic viscosity of 0.62 dl/g.

### (Preparation of Polyethylene Terephthalate Calcium Carbonate Masterbatch (MB1))

The PET (I) and calcium carbonate particles having an average particle diameter of 1.0 μm were melted and kneaded with a biaxial extruder to prepare a masterbatch having a calcium carbonate particle concentration of 10,000 ppm.

### Example 1

Recycled PET 1 was supplied to an extruder and melted at 280° C. This polymer was filtered through a filter medium of stainless steel sintered body (nominal filtration accuracy: cutting 95% of 10 μm particles), and extruded into a sheet shape from a mouthpiece, and the sheet was then brought into contact with a casting drum having a surface temperature of 30° C. and cooled and solidified by an electrostatic casting method, thereby fabricating an un-stretched film. This un-stretched film was uniformly heated to 75° C. using a heating roll, heated to 85° C. using a non-contact heater, and subjected to 3.5-fold roll stretching (longitudinal stretching). Thereafter, the mixture was guided to a tenter, preheated at 125° C., then transversely stretched 4.5 times at 140° C., subjected to width fixing, and heat fixing at 245° C. for 5 seconds, and relaxed by 3% in the transverse direction at 220° C. to obtain a polyethylene terephthalate film having a thickness of 31 μm. The evaluation results are shown in Table 2.

### Example 2

The raw material was changed to recycled PET 2 without changing the stretching conditions from Example 1. The thickness was adjusted by changing the speed at the time of casting, to obtain a biaxially stretched polyethylene terephthalate film having a thickness of 19 μm.

### Examples 3, 4

The thickness was adjusted by changing the speed at the time of casting from Example 2, to obtain a biaxially stretched polyethylene terephthalate film having a thickness shown in Table 2.

### Example 5

A biaxially stretched polyethylene terephthalate film in which the raw material was changed from that in Example 3 to recycled PET 3 was obtained.

### Example 6

Using a co-extruder, an un-stretched film having an A/B/A configuration in which an A layer obtained by mixing 75% of recycled PET 2 and 25% of recycled PET 4 was laminated on a surface layer by 10% and 100% of recycled PET 2 was laminated on a B layer was stretched in the same manner as in Example 3 to obtain a biaxially stretched polyethylene terephthalate film.

In Example 6 having the A/B/A layer configuration, the B layer is made of a first composition containing the release layer and recycled PET obtained by recycling the substrate, but the A layer is more preferably made of a second composition containing recycled PET obtained by recycling only the substrate from which not only an attachable matter but also the release layer has been removed. With this configuration, the A layer exposed to the surface can have high smoothness.

### Example 7

A biaxially stretched polyethylene terephthalate film in which the raw material was changed as shown in Table 2 from that in Example 6 was obtained.

In Example 7 having an A/B/A layer configuration, a B layer is made of a first composition containing a release layer and recycled PET obtained by recycling a substrate, but an A layer is more preferably made of a second composition containing recycled PET obtained by recycling only the substrate from which not only an attachable matter but also the release layer has been removed. With this configuration, the A layer exposed to the surface can have high smoothness.

### Examples 8 to 10

A biaxially stretched polyethylene terephthalate film in which the raw material was changed as shown in Table 1 from that in Example 3 was obtained.

### Reference Example 1

As Reference Example, a biaxially stretched film containing a polyethylene terephthalate pellet (PET (I)) and a polyethylene terephthalate calcium carbonate masterbatch (MB1) not containing a recycled raw material was formed in the same manner as in Example 1. The results are shown in Table 2.

### Comparative Example 1

A used PET film including a silicone-based release layer on one surface and containing 600 ppm of calcium carbonate having a particle diameter of 1.0 μm was pelletized without removing a residue of the silicone release layer and a ceramic green sheet. A film was formed by using the obtained pellet in the same manner as in Example 1. An attempt was made to form a coating layer on the obtained film, but cissing occurred in a part of the film, and the defect rate of the processed product increased. Unevenness was transferred to the processed product due to coarse protrusions caused by a residue, and the defect rate increased.

### Comparative Example 2

A used PET film including a silicone-based release layer on one surface and containing 600 ppm of calcium carbonate having a particle diameter of 1.0 μm was pelletized after the residue of a silicone release layer and a ceramic green sheet were removed by light irradiation and water washing. A film was formed by using the obtained pellet in the same manner as in Example 1. An attempt was made to form a coating layer on the obtained film, but cissing occurred in a part of the film, and the defect rate of the processed product increased. Unevenness was transferred to the processed product due to coarse protrusions caused by a residue, and the defect rate increased.

When the film according to Example was marked with an oil-based marker pen and used as a process paper for processing an IC chip, a good processed product was obtained with good print visibility and no transfer of surface unevenness to the IC chip.

Furthermore, the use of a film obtained by material recycling made it possible to produce an environmentally friendly product. For example, it was possible to exhibit performance equivalent to that of the biaxially stretched film without using a recycled raw material shown in Reference Example 1.

It is presumed that in Comparative Example 1, for example, the surface roughness SRa exceeds the scope of the present invention due to the residue. In Comparative Example 2, the residue is not sufficiently removed, and for example, it is presumed that the surface roughness SRa exceeds the range of the present invention.

TABLE 1

| | | Inorganic substance 1 | | | | Inorganic substance 2 | | |
|---|---|---|---|---|---|---|---|---|
| | | | Average | | | | Average | |
| | | | particle | | | | particle | |
| | Polymer | Type | diameter | Content | | Type | diameter | Content |
| Recycled PET 1 | PET | CaCO3 | 1.0 μm | 600 | ppm | | | |
| Recycled PET 2 | PET | CaCO3 | 1.0 μm | 1000 | ppm | | | |
| Recycled PET 3 | PET | CaCO3 | 0.5 μm | 2300 | ppm | | | |
| Recycled PET 4 | PET | CaCO3 | 1.0 μm | 1000 | ppm | SiO2 | 2.5 μm | 10000 ppm |
| Recycled PET 5 | PET | SiO2 | 2.5 μm | 300 | ppm | | | |
| Recycled PET 6 | PET | SiO2 | 2.5 μm | 600 | ppm | | | |
| Recycled PET 7 | PET | SiO2 | 2.5 μm | 900 | ppm | | | |
| PET 1 | PET | — | — | — | | | | |
| MB1 | PET | CaCO3 | 1.0 μm | 10000 | ppm | | | |

TABLE 2

| | Layer | | | | | | | Use | | | | | | | | Envi- |
|---|---|---|---|---|---|---|---|---|---|---|---|---|---|---|---|---|
| | con- | A layer | | | | B layer | | rate | | | | | | | | ron- |
| | fig- | Raw | | Raw | | Raw | | of re- | Thick- | | | | | | Print | mental |
| | ura- | mate- | Ratio | mate- | Ratio | mate- | Ratio | cycled | ness | HAZE | SRa | SRz | SRp | IV | visi- | re- |
| | tion | rial 1 | % | rial 2 | % | rial 1 | % | resin % | μm | % | nm | nm | nm | dl/g | bility | sponse |
| Example 1 | A | Recycled | 100 | — | — | — | — | 100 | 31 | 5.5 | 10 | 388 | 435 | 0.534 | ◯ | ◯ |
| | | PET 1 | | | | | | | | | | | | | | |
| Example 2 | A | Recycled | 100 | — | — | — | — | 100 | 18 | 7.0 | 15 | 526 | 526 | 0.532 | ◯ | ◯ |
| | | PET 2 | | | | | | | | | | | | | | |
| Example 3 | A | Recycled | 100 | — | — | — | — | 100 | 25 | 9.4 | 16 | 514 | 516 | 0.532 | ◯ | ◯ |
| | | PET 2 | | | | | | | | | | | | | | |
| Example 4 | A | Recycled | 100 | — | — | — | — | 100 | 31 | 9.9 | 16 | 472 | 455 | 0.533 | ◯ | ◯ |
| | | PET 2 | | | | | | | | | | | | | | |
| Example 5 | A | Recycled | 100 | — | — | — | — | 100 | 25 | 8.1 | 16 | 400 | 386 | 0.519 | ◯ | ◯ |
| | | PET 3 | | | | | | | | | | | | | | |
| Example 6 | A/B/ | Recycled | 98.5 | Recycled | 1.5 | Recycled | 100 | 100 | 25 | 7.1 | 16 | 701 | 804 | 0.526 | ◯ | ◯ |
| | A | PET 2 | | PET 4 | | PET 2 | | | | | | | | | | |
| Example 7 | A/B/ | Recycled | 94 | Recycled | 6 | Recycled | 100 | 100 | 25 | 8.1 | 21 | 1213 | 1187 | 0.525 | ◯ | ◯ |
| | A | PET 2 | | PET 4 | | PET 2 | | | | | | | | | | |
| Example 8 | A | Recycled | 100 | — | — | — | — | 100 | 25 | 2.0 | 20 | 731 | 883 | 0.532 | Δ | ◯ |
| | | PET 5 | | | | | | | | | | | | | | |
| Example 9 | A | Recycled | 100 | — | — | — | — | 100 | 25 | 2.8 | 21 | 1213 | 1187 | 0.532 | Δ | ◯ |
| | | PET 6 | | | | | | | | | | | | | | |
| Example | A | Recycled | 100 | — | — | — | — | 100 | 25 | 5.1 | 40 | 1501 | 1700 | 0.532 | ◯ | ◯ |
| 10 | | PET 7 | | | | | | | | | | | | | | |
| Reference | A | PET 1 | 90 | MB1 | 10 | — | — | 0 | 25 | 9.5 | 17 | 516 | 517 | 0.585 | ◯ | Δ |
| Example 1 | | | | | | | | | | | | | | | | |

### INDUSTRIAL APPLICABILITY

By producing a recycled film containing particles by the method of the present invention, print visibility was good, and the transfer of surface unevenness could be suppressed. Furthermore, the present invention, which is advantageous in terms of effective use of resources and cost by material recycling, greatly contributes to the industry.

1. A biaxially stretched polyester film having a haze of 2% or more and 15% or less and a surface roughness SRa of at least one surface of 5 nm or more and 40 nm or less.

2. The biaxially stretched polyester film according to claim 1, comprising 80 mass % or more and 100 mass % or less of a resin obtained by material-recycling a used film with a functional layer containing one or more kinds of inorganic particles or organic particles.

3. The biaxially stretched polyester film according to claim 1, wherein the biaxially stretched polyester film has an intrinsic viscosity IV of 0.50 dl/g or more and 0.70 dl/g or less.

4. The biaxially stretched polyester film according to claim 1, wherein the biaxially stretched polyester film is used as a substrate film in a release film for producing a resin sheet.
